(19) United States
(12) Patent Application Publication
(10) Pub. No.: US 2020/0092978 A1
(43) Pub. Date: Mar. 19, 2020

(54) ELECTROMAGNETIC WAVE DISCHARGE EMISSION DEVICE

(71) Applicant: IMAGINEERING, Inc., Kobe-shi, Hyogo (JP)

(72) Inventors: Yuji Ikeda, Kobe-shi (JP); Seiji Kanbara, Kobe-shi (JP)

(73) Assignees: IMAGINEERING, Inc., Kobe-shi, Hyogo (JP); IMAGINEERING, Inc., Kobe-shi, Hyogo (JP)

(21) Appl. No.: 15/748,996

(22) PCT Filed: Aug. 1, 2016
(86) PCT No.: PCT/JP2016/072513

§ 371 Date: Jan. 30, 2018

(30) Foreign Application Priority Data
Jul. 31, 2015 (JP) 2015-151488

(51) Int. Cl. H05H 1/46; H05H 1/52; F02P 23/04; H05B 6/68; H05B 6/70; H05B 6/72; H05B 6/80

(52) U.S. Cl. CPC H05H 1/46; H05H 1/52; F02P 23/045; H05H 2001/463; H05B 6/702; H05B 6/72; H05B 6/80; H05B 6/686

(57) ABSTRACT

To provide an electromagnetic wave discharge emission device, a discharger in small size for causing a discharge only by an electromagnetic wave, that can significantly be reduced in length in a longitudinal direction, and configured to emit the electromagnetic wave into a target space based on an output of the supplied electromagnetic wave. The electromagnetic wave discharge emission device comprises an electromagnetic wave oscillator MW configured to oscillate an electromagnetic wave, a controller 2 configured to control the electromagnetic wave oscillator MW, a first substrate 10 provided with a plurality of discharge emission patterns 11 each having a power receiving end 11a on the main surface side, and a second substrate 20 provided with a feed pattern 22 having a power receiving port 21 configured to receive a power of the electromagnetic wave from the electromagnetic wave oscillator MW and a plurality of power feed ends 22a each connected through a via to one of the power receiving ends 11a, a distance on the feed pattern 22 from the power receiving port 21 to each power receiving end 11a of the corresponding discharge emission pattern 11 being equal to one another. Each of the discharge emission patterns 11 is formed in a spiral shape that has at a center thereof the corresponding power receiving end (s) 11a connected to the feed pattern 22 and has a length which corresponds to ¼ wavelength of the electromagnetic wavelength supplied to the feed pattern 22.

### TECHNICAL FIELD

The present invention relates to an electromagnetic wave discharge emission device that functions as a discharger and an emitter, the discharger for causing a discharge by an electromagnetic wave in a target space based on an output of supplied electromagnetic wave, and the emitter for emitting the electromagnetic wave into the target space.

### BACKGROUND ART

Inventors suggested a plasma generation device as a discharger for ignition in the internal combustion engine, which can be used as an igniter in small size for the internal combustion engine that can efficiently generate, expand and maintain plasma only by using the electromagnetic wave. The plasma generation device comprises integrally together an electromagnetic wave oscillator configured to oscillate an electromagnetic wave, a controller configured to control the electromagnetic wave oscillator, a boost circuit including a resonation circuit capacitively-coupled to the electromagnetic wave oscillator, and a discharge electrode configured to discharge high voltage generated by the boost circuit (for example, referring to Patent Document 1).

### PRIOR ART DOCUMENTS

### Patent Document(s)

Patent Document 1: WO2014/115707

### SUMARRY OF INVENTION

### Problem to be Solved by Invention

The plasma generation device described in Patent Document 1 that can be used as the igniter, can be reduced significantly in outer diameter compared to the conventional spark plug, fuel (air mixture) supplied into the combustion chamber can surely be combusted, and the combustion timing can arbitrarily be adjusted by arranging a plurality of the plasma generation devices in the internal combustion engine and forming multiple discharging parts.

However, even with the plasma generation device that can significantly be reduced in outer diameter length compared to the conventional spark plug, length in a longitudinal direction cannot significantly be reduced, there is a limitation in number of mounting holes to be formed in an engine head of the internal combustion engine, and arranging number also has a limitation, for example, about four to eight.

Moreover, an electromagnetic wave emitter in small size with low cost is desirable, which can be used to a microwave heating device configured to heat-up an object by using an electromagnetic wave (microwave).

The present invention is made from the above viewpoints, and an objective is to provide an electromagnetic wave discharge emission device, a discharger in small size that causes a discharge only by an electromagnetic wave, in which a length in a longitudinal direction can significantly be reduced, and the electromagnetic wave can be emitted into a target space based on an output of supplied electromagnetic wave.

### Means for Solving Problem

An electromagnetic wave discharge emission device of the present invention comprises an electromagnetic wave oscillator configured to oscillate an electromagnetic wave, a controller configured to control the electromagnetic wave oscillator, a first substrate provided with a plurality of discharge emission patterns each having a power receiving end, and a second substrate provided with a feed pattern having a power receiving port configured to receive a power of the electromagnetic wave from the electromagnetic wave oscillator and a plurality of power feed ends each connected through a via to one of the power receiving ends, a distance on the feed pattern from the power receiving port to each power receiving end of the corresponding discharge emission pattern being equal to one another. Each of the discharge emission patterns is formed in a spiral shape that has at a center thereof around the corresponding power receiving end connected to the feed pattern and has a length which corresponds to ¼ wavelength of the electromagnetic wavelength supplied to the feed pattern.

According to an electromagnetic wave discharge emission device of the present invention, when an output of supplied electromagnetic wave is increased. 1.6 kW for example, the device functions as an electromagnetic wave discharger, and when the output of the supplied electromagnetic wave is lowered, 300 W for example, the device functions as an electromagnetic wave emitter.

In this case, through the controller, a control of discharge that causes a discharge at a gap between an opening end of each discharge emission pattern and part of the discharge emission pattern which is close to the opening end, can be performed by supplying from the electromagnetic wave oscillator the electromagnetic wave having an output value that causes the breakdown at the gap. The output value of the electromagnetic wave that causes the breakdown at the gap, being different based on a width length of the gap, can easily be known by changing the output value by the controller. Thereby, the electromagnetic wave discharge emission device can be used as the discharger for the internal combustion engine for example.

Moreover, in this case, an emission of the electromagnetic wave from the surface of respective discharge emission patterns can be controlled through the controller by supplying from the electromagnetic wave oscillator an electromagnetic wave having an output value lower than an output value that causes a breakdown at a gap between an opening end of each discharge emission pattern and part of the discharge emission pattern which is close to the opening end. Thereby, the electromagnetic wave discharge emission device can be used as a microwave emission antenna of a microwave heating device, for example.

Further, in this case, by using the controller, a control of discharge for causing a discharge at a gap between an opening end of each discharge emission pattern and part of the discharge emission pattern which is close to the opening end, can be controlled by supplying from the electromagnetic wave oscillator the electromagnetic wave having a first output value that causes a breakdown at the gap, and further, a control of emission of the electromagnetic wave from the surface of the respective discharge emission patterns can be controlled by supplying from the electromagnetic wave oscillator the electromagnetic wave having a second output value lower than the first output value.

By switching to perform the discharge control and the emission control by the controller, when used as the igniter of the internal combustion engine, the electromagnetic wave is emitted at a timing except for the ignition timing, and OH radicals and O₂ radicals are generated inside the combustion chamber so as to contribute to a combustion enhancement. Moreover, expansion and maintaining of flame that is generated only by tire electromagnetic wave can efficiently be performed.

### Effect of Invention

A main component part of an electromagnetic wave discharge emission device of the present invention is a discharge emission part formed in substrate manner in two-layer-structure comprising a first substrate and a second substrate, a plurality of discharge emission patterns formed so as to cause a discharge gap on a main surface of the first substrate are provided, functioned as a discharger for causing a discharge by an electromagnetic wave in a target space based on an output of supplied electromagnetic wave, and functioned as an emitter, i.e., an emission antenna for emitting an electromagnetic wave into the target space, and therefore, they can be mounted like a sticker, on a surface exposed to a combustion chamber of a cylinder head and on a piston head in an internal combustion engine, and in a case of a microwave heating device, a plurality of the discharge emission patterns can easily be arranged on a ceiling, a bottom surface, and a side surface of a heating room.

### BRIEF DESCRIPTION OF FIGURES

FIG. 1 shows an example that forms a discharge emission pattern of an electromagnetic wave discharge emission device of the present invention at four places, (a) is a front view seen from a main surface side of a first substrate, (b) is a back view seen from a back surface side of a second substrate, and (c) is a main-part-enlarged view of the discharge emission pattern.

FIG. 2 shows an example that forms the discharge emission pattern of the electromagnetic wave discharge emission device of the present invention at sixteen places, (a) is the front view seen from the main surface side of the first substrate, (b) is the back view seen from the back surface side of the second substrate, (c) is a perspective view seen from the main surface side of the first substrate, and (d) is the perspective view seen from the back surface side of the second substrate.

FIG. 3 is a front-cross-sectional view that shows an internal combustion engine of a first embodiment.

FIG. 4 is a bottom view of a cylinder head of the internal combustion engine seen from a combustion chamber side.

FIG. 5 is a schematically front view that shows a heating device of a second embodiment.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

### First Embodiment

### Electromagnetic Wave Discharge Emission Device as Igniter (Discharger) of Internal Combustion Engine

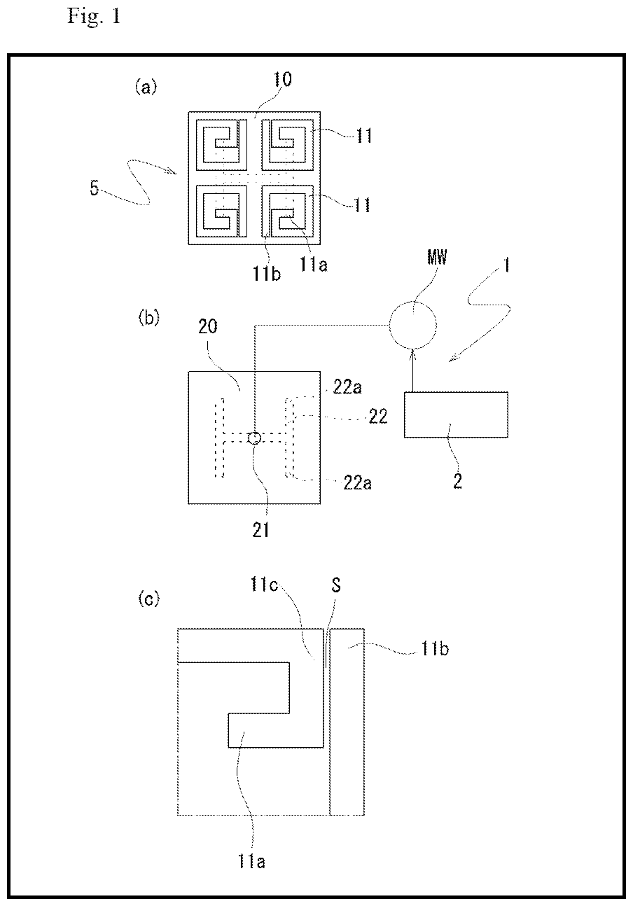

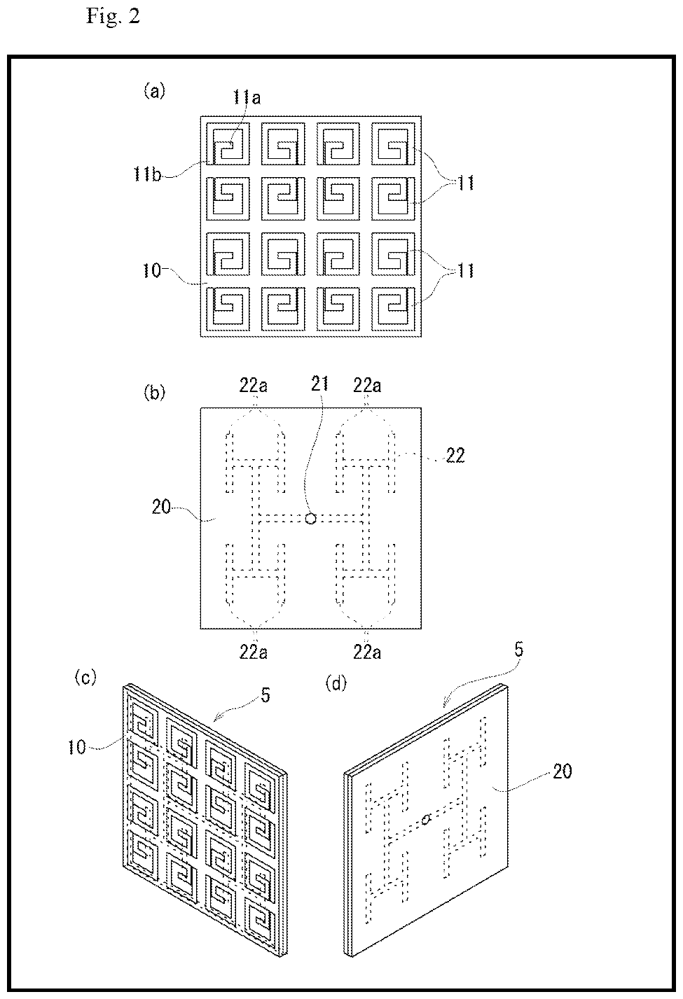

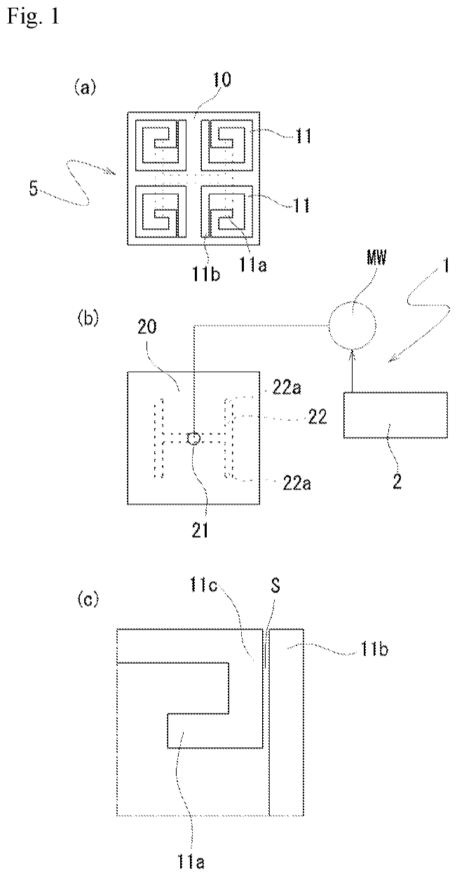

The present first embodiment is an example for using an electromagnetic wave discharge emission device regarding the present invention as an igniter of an internal combustion engine. The electromagnetic wave discharge emission device 1, as illustrated in FIG. 1, comprises an electromagnetic wave oscillator MW configured to oscillate an electromagnetic wave, a controller 2 configured to control the electromagnetic wave oscillator MW, a first substrate 10 provided with a plurality of discharge emission patterns 11 on a main surface side, and a second substrate 20 provided with a feed pattern 22 having a power receiving port 21 configured to receive a power of the electromagnetic wave from the electromagnetic wave oscillator MW and a plurality of power feed ends 22a each connected through a via to one of the power receiving ends 11a, a distance on the feed pattern 22 from the power receiving port 21 to each power receiving and 11a of the corresponding discharge emission pattern 11 being equal to one another. Each of the discharge emission pattern 11 is formed in a spiral shape that has a center thereof around the power receiving end 11a connected to the feed pattern 22, and has a length which corresponds to ¼ wavelength of the electromagnetic wavelength supplied to the feed pattern 22.

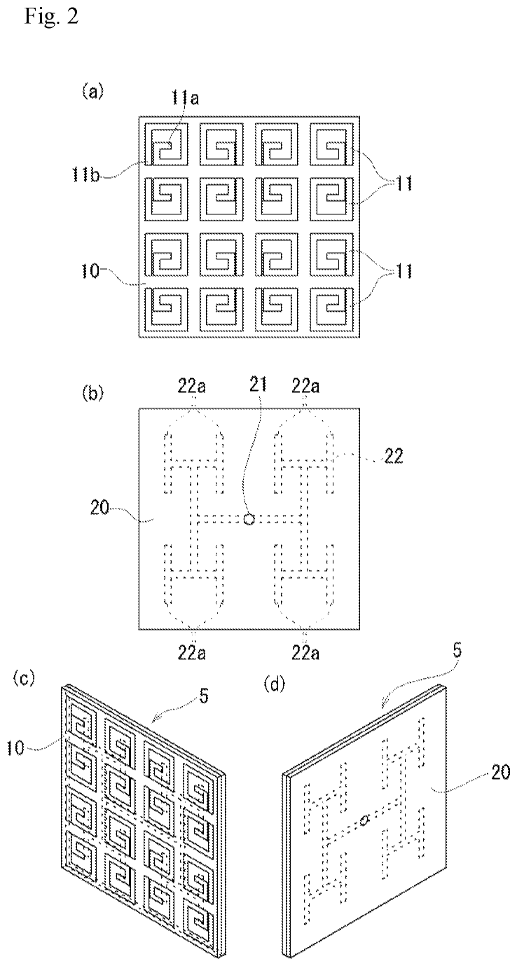

The first substrate 10 and the second substrate 20 respectively form, on their main surfaces, the discharge emission pattern 11 and the feed pattern 22. The feed pattern 22 is connected, through the via, to a power receiving port 21 formed on a back surface of the second substrate 20, and each distance from a plurality of power feed ends 22a (four parts in an example of FIG. 1, sixteen parts in an example of FIG. 2) connected, through the via, to respective power receiving ends 11a as a power receiving point of the discharge emission pattern 11, to the power receiving port 21, is configured to be equal. A thickness of the first substrate 10 and the second substrate 20 is not specifically limited: however, in the present embodiment, formed in about 0.2 mm, and both the substrates are laminated so as to constitute a discharge emission part 5.

The first substrate 10 and the second substrate 20 are specifically not limited in material; however, for example, powder of ceramics (in below, may referred to “ceramic raw material”) such as alumina Al₂O₃, aluminum nitride, cordierite, mullite is fired to be formed. Moreover, the discharge emission pattern 11 and the power feed pattern 22 are specifically not limited in material; however, metal power-based conductive paste, the metal powder such as silver with low electricity resistance, copper, tungsten, molybdenum is printed on the first substrate 10 and the second substrate 20 by a method such as screen printing so as to form the above structure (referring to FIG. 1 and FIG. 2).

The electromagnetic wave discharge emission device 1 is controlled by the controller 2, to cause a discharge at a gap S between an opening end 11b of the discharge emission pattern 11 and part 11c of the discharge emission pattern 11 which is close to the opening end 11b, by supplying from the electromagnetic wave oscillator MW an electromagnetic wave having an output value that causes a breakdown at the gap S. At that moment, a length of the discharge emission pattern 11 is set to be ¼ wavelength with respect to the supplied electromagnetic wavelength, and thereby, an electric field strength in the vicinity of the gap S is enhanced, and the discharge can easily be performed.

The discharge emission pattern 11 formed in a spiral shape that has at a center thereof around the corresponding power receiving end 11a, can be formed in a helical manner; however, in the present embodiment, pattern extended from the power receiving end 11a in straight line is repeatedly bent in right angle to form the discharge emission pattern 11. The length of the discharge emission pattern 11 is configured to become ¼ wavelength with respect to the supplied electromagnetic wavelength. Specifically, the discharge emission pattern 11 of the present embodiment uses alumina about 8.5 dielectric constant as a material of the first substrate 10, and it is configured that the pattern width is 1 mm and the whole length in a longitudinal direction is about 25 mm. The frequency of the electromagnetic wave supplied from the electromagnetic wave oscillator MW becomes 2.45 GHz. Moreover, the discharge emission pattern 11 is formed such that the length of the gap S between the opening end 11b and the discharge emission pattern part 11c which is close to the opening end 11b, in the present embodiment, becomes from about 0.1 mm to 0.3 mm.

When the electromagnetic wave discharge emission device 1 is used as the discharger, an output value that causes the breakdown at the gap S differs based on the number of the discharge emission pattern 11 and the gap S distance between the opening end 11b of the discharge emission pattern 11 and the discharge emission pattern part 11c which is close to the opening end 11b. Therefore, the output power of the electromagnetic wave supplied from the electromagnetic wave oscillator MW is variably controlled, a suitable-dischargeable output value is measured, and then makes the controller 2 memorize the output value in advance.

The electromagnetic wave oscillator MW is for example a semiconductor oscillator. The electromagnetic wave oscillator MW is electrically connected to an electromagnetic-wave-power-source (omitted in figure). If the power source receives an electromagnetic wave oscillation signal, for example, TTL signal, from the controller 2, pulse current in a pattern set of a predetermined duty ratio, a predetermined pulse time of period and etc., is outputted to the electromagnetic wave oscillator MW. When the electromagnetic wave oscillator MW receives the pulse current from the electromagnetic-wave-power-source, it outputs a microwave pulse to the power receiving port 21. The irradiated electromagnetic wave output power, frequency, phase, duty ratio, and pulse time period, can easily be controlled and changed by using the semiconductor oscillator.

—Internal Combustion Engine—

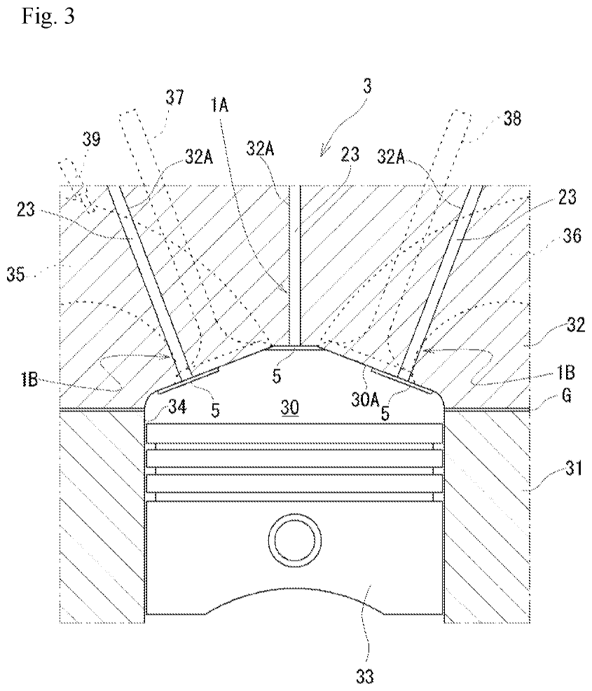

An internal combustion engine 3 provided with the electromagnetic wave discharge emission device 1 of the present first embodiment is explained in below. The electromagnetic wave discharge emission device 1 generates microwave plasma at a combustion chamber 30 being as a target space. The internal combustion engine 3 is as illustrated in FIG. 3 a reciprocating type gasoline engine; however; not limited to this type. The internal combustion engine 3 comprises a plurality of electromagnetic wave discharge emission devices 1 as the igniter or a discharger in the engine body on a ceiling surface 30A of a cylinder head 32.

The internal combustion engine 3 comprises a cylinder block 31, a cylinder head 32, and a piston 33. In the cylinder block 31, a plurality of cylinders 34 in a circular shape at the cross-section is formed. Inside each cylinder 34, a piston 33 is provided in a freely reciprocating manner. The piston 33 is connected to a crankshaft via a connecting rod (omitted in figure). The crankshaft is supported in freely-rotatable by the cylinder block 31. When the piston 33 performs reciprocation in an axial direction of the cylinder 34, the reciprocation movement of the piston 33 is changed into the rotation of the crankshaft by the connecting rod.

The cylinder head 32 is mounted on the cylinder block 31 by sandwitching a gasket G. The cylinder head 32, the cylinder 34, and the piston 33, define the combustion chamber 30.

In the cylinder head 32, a plurality of the discharge emission patterns 11 of the discharge emission part 5 of the electromagnetic wave discharge emission device 1 is arranged so as to expose toward the combustion chamber 20 with respect to each cylinder 34. In the cylinder head 32, a supply path 32A for allowing a passage of an electromagnetic wave supply means 23, for example, a semi-rigid coaxial cable for supplying an electromagnetic wave, microwave from the electromagnetic wave oscillator MW into the power receiving port 21, is opened.

In the cylinder head 32, an intake port 35 and an exhaust port 36 are formed with respect to the cylinder 34. In the intake port 35, an intake valve 37 is provided so as to open and close the intake port 35. On the other hand, in the exhaust port 36, an exhaust valve 38 is provided so as to open and close the exhaust port 36.

An injector 39 for fuel injection is provided one by one with respect to the cylinder 34. The injector 39 forms an inject hole at an upstream side of at least one of two intake ports 35, and injects fuel into the combustion chamber with intake air. Moreover, the injector 39 may be configured as so-called direct-inject-type that is exposed toward the combustion chamber 30 from an interval between openings of two intake ports 35. In this case, the injector 39 injects fuel in a different way from a plurality of injecting ports. When adopting a direct-inject-type, the fuel is injected towards a top surface of the piston 33. Moreover, the injector 39 may be twin-injector-system that the injector 39 is provided at both the intake port and the combustion chamber.

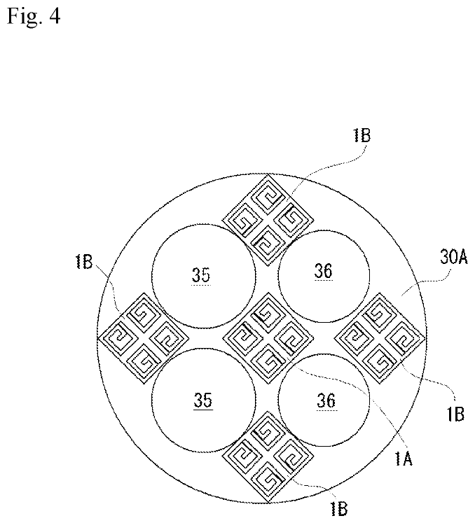

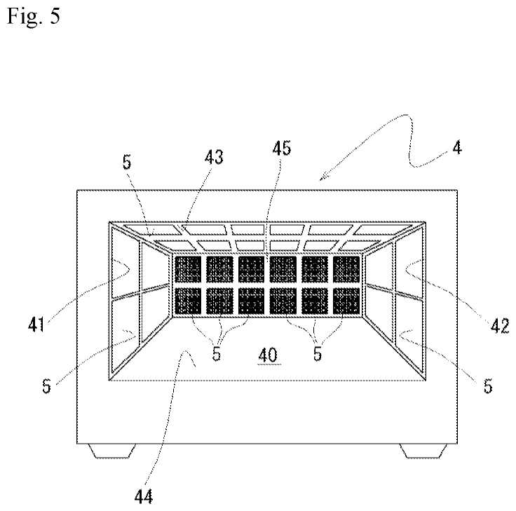

An arranging position of an electromagnetic wave discharge emission device 1 (1A, 1B) is not specifically limited; however, in the present embodiment, as illustrated in FIG. 4, arranged at a center of the ceiling 30A of the combustion chamber 30, i.e., surface exposed to the combustion chamber 30 of the cylinder head 32, between the intake ports 35, 35 of the cylinder head 22, between the exhaust ports 36, 36, and between the intake port 35 and the exhaust port 36. Here, the combustion chamber ceiling of the internal combustion engine indicates a surface exposed to the combustion chamber 30 at the cylinder head 32, and includes a surface parallel to the piston 33.

The discharge of the respective electromagnetic wave discharge emission devices 1 is performed through the controller 2 by supplying the electromagnetic wave into the respective electromagnetic wave discharge emission devices 1. In this case, control can be performed so that each of them can discharge in respectively different timing. Thereby, the size reduction of the electromagnetic-wave-power-source for supplying pulse current into the electromagnetic wave oscillator MW and a low-capacity of a semiconductor chip for electromagnetic wave oscillation of the electromagnetic wave oscillator MW are promoted. Moreover, the pulse current supplied into the electromagnetic wave discharge emission device 1 that discharges thereafter the first discharger 1, can be lower output power. The above structure adoption is effective in that an electromagnetic wave discharge emission device 1A that discharges at first is arranged at the center of the ceiling 30A, a firing seed for igniting the fuel mixture is generated by discharge, i.e., spark discharge from the electromagnetic wave discharge emission device 1A, the discharge from the electromagnetic wave discharge emission devices 1B thereafter maintains and expands plasma generated by the first discharge, and total consumption electric power reduction can be achieved. Accordingly, in the electromagnetic wave discharge emission devices 1 except for the electromagnetic wave discharge emission device 1 arranged at the center of the ceiling 30A, as an output that does not occur breakdown into the combustion chamber 30, it can also be controlled of emission of the electromagnetic wave, microwave.

A heat loss occurring at the cylinder wall surface can be reduced by discharging the electromagnetic wave discharge emission devices 1B arranged at circumferential side and directing flame orientation from the circumferential side to the center. In that moment, the heat loss reduction effect can further be enhanced by existing EGR gas in the vicinity of the cylinder wall surface by using swale flow.

Moreover, by the controller 2, the discharge control for causing a discharge at the gap S between the opening end 11b of the discharge emission pattern 11 and the electromagnetic wave discharge emission pattern part 11c which is close to the opening end 11b by supplying from the electromagnetic wave oscillator MW an electromagnetic wave having the first output value that causes the breakdown at the gap S, and the emission control for emitting the electromagnetic wave from the surface of each discharge emission pattern 11 by supplying from the electromagnetic wave oscillator MW an electromagnetic wave having the second output value lower than the first output value, can be switched based on respective processes of the internal combustion engine.

By switching to perform the discharge control and the emission control by the controller 2, when used as the igniter of the internal combustion engine, the electromagnetic wave having the second output value is emitted on a timing except for the ignition timing, OH radicals and O₂ radicals are generated inside the combustion chamber 20, which can contribute to the combustion enhancement. Thereby, expansion and maintaining of the flame generated only by the electromagnetic wave can efficiently be performed.

Further, in the present embodiment, an example that the electromagnetic wave discharge emission device 1 is arranged on the ceiling 30A of the cylinder head 32, is explained, but not limited to the above, and the electromagnetic wave discharge emission device 1 can also be configured so as to arrange on the top surface of the piston 33.

### Effect of First Embodiment

The electromagnetic wave discharge emission device 1 used as the igniter, i.e., discharger in the internal combustion engine of the present first embodiment, may be configured only to open the supply path 32A in small diameter at the cylinder head 32, that allows for passage of an electromagnetic wave supply means 23, and the electromagnetic wave discharge emission device 1 provided with four discharge emission patterns 11 on the first substrate 10 can be formed on the ceiling 30A of the cylinder head 32 at five places. Thereby, a multi-point ignition having a discharge point in number of 20 discharge places can be realized.

Moreover, HCCI, Homogeneous-Charge Compression Ignition system can be adopted as the internal combustion engine. The HCCI system is the gasoline self-ignition system like diesel engine, and it is difficult to control the system since the ignition timing depends on the combustion chamber inside temperature. Therefore, temperature inside the combustion chamber can easily be controlled by using the electromagnetic wave discharge emission device 1 of the present invention and controlling the output of the electromagnetic wave and etc, and as the result, defects of the HCCI system can be compensated.

By using the electromagnetic wave discharge emission device 1 as the igniter, a flame ignition place can be controlled, and knocking occurred at the internal combustion engine can effectively prevented. In this case, a knocking sensor is also used together, and the knocking can more-surely be suppressed by performing the ignition control according to the knocking occurrence places.

Further, by reducing the heat loss and adjusting a start timing of discharge from the electromagnetic wave discharge emission device 1 after the air mixture ignition, a heat generation position can be controlled. These controls, i.e., control of a discharge output power, a discharge position, a discharge timing, can be performed in nanosecond, “nsec” order by using a semiconductor chip, i.e., RF chip as the electromagnetic wave oscillator MW.

### Second Embodiment

### Electromagnetic Wave Discharge Emission Device as Electromagnetic Wave Dischsrger of Heater

The second present embodiment is an example that the electromagnetic wave discharge emission device of the present invention is used as an electromagnetic wave discharger of a heater. The electromagnetic wave discharge emission device 1 has a similar configuration of the electromagnetic wave discharge emission device 1 of the first embodiment, and a point different from the first embodiment is as follows; specifically, the electromagnetic wave emission from the surface of each discharge emission pattern, is controlled through the controller 2, by supplying from the electromagnetic wave oscillator MW an electromagnetic wave having the output value no greater than the value that the breakdown is occurred at the gap S between the opening end 11b of the discharge emission pattern 11 and the discharge emission pattern part 11c which is close to the opening end 11b.

—Heater—

A heater 4 provided with the electromagnetic wave discharge emission device 1 regarding the present embodiment 2 is explained. The heater 4 is a heater that utilizes a dielectric heating, and a heating room 40 is configured to freely open and close a front surface by open-close door (not illustrated), and formed by a left side plate 41, a right side plate 42, a ceiling plate 43, a bottom plate 44, and a depth plate 45 which are made from a metal material.

The discharge emission part 5 of the electromagnetic wave discharge emission device 1 is arranged on the surface of at least one plate (From the figure example, the discharge emission part 5 is arranged on four plates except for the bottom plate 44). The discharge emission parts 5 are preferably arranged with separated from each other having a predetermined distance so as not to influence on the electromagnetic wave emission, or preferably interposed of an insulator between each plate and the discharge emission part 5, since each plate is made of the metal material. Moreover, a turntable (not illustrated) and etc. is generally required to be arranged at the bottom plate 44, and when the discharge emission part 5 is arranged on the bottom plate 44, it is located below the turntable.

The discharge emission part 5 of the electromagnetic wave discharge emission device 1 as the electromagnetic wave discharger may use, as illustrated in FIG. 1, the discharge emission part that forms the discharge emission patterns 11 at four places on the main surface of the first substrate 10; however, as illustrated in FIG. 2, it is preferable to use the discharge emission part that forms the discharge emission patterns 11 at sixteen places on the main surface of the first substrate 10.

The electromagnetic wave discharge emission device 1 is configured to provide one electromagnetic wave oscillator MW, by use of the controller 2, and the distributer or the switcher into each plate of the discharge emission parts 5, and in other case, it is configured that the electromagnetic wave oscillator MW is prepared and arranged per each plate, and the electromagnetic wave or microwave supply can be controlled per each plate.

Moreover, a detector for detecting a state of a progressive wave and a reflection wave of the electromagnetic wave supplied, for example, a directional coupler and a wave-detector, is arranged between the electromagnetic wave oscillator MW and the discharge emission part 5, the reflection wave from each discharge emission part 5 is detected, and thereby, a discharge emission part 5 existing at a proper position that is different based on an object heat target inside the heating room 40, is detected, and the control can also be performed by the controller 2 with respect to the discharge emission part 5 at the proper position such that the output value of the electromagnetic wave supplied can be changed.

### Effect of Second Embodiment

A plurality of electromagnetic wave discharge emission devices 1 used as the electromagnetic wave emitters of the heater regarding the present embodiment 2 is arranged at each plate of the heating room 20 as multiple emission antennas, and the electromagnetic wave or microwave is emitted into an object heat target from the electromagnetic wave discharge emission device 1 existing at a proper distance, and the object heat target can efficiently be heat-processed.

Moreover, the electromagnetic wave discharge emission device 1 differs only in a control way by the controller 2, the component parts are similar to the electromagnetic wave discharge emission device 1 used as the igniter of the internal combustion engine, and the manufacturing cost can be reduced.

### INDUSTRIAL APPLICABILITY

As illustrated as above, the electromagnetic wave discharge emission device of the present invention, when used as the discharger, is suitably used to the internal combustion engine and etc. such as a vehicle engine. Moreover, when the electromagnetic wave discharge emission device is used as the emitter, it can suitably be utilized to a heater that utilizes the dielectric heating represented by microwave oven, and in other case, it can suitably utilized to a garbage disposal unit and etc.

### NUMARAL SYMBOLS EXPLANATION

1. Electromagnetic Wave Discharge Emission Device
10. First Substrate
11. Discharge Emission Pattern
11a. Power Receiving End
11b. Opening End
2. Controller
20. Second Substrate
21. Power Receiving Port
22. Feed Pattern
22a. Power Feed End
3. Internal Combustion Engine
4. Heater
MW Electromagnetic Wave Oscillator
S. Space Gap

1. An electromagnetic wave discharge emission device comprising:
an electromagnetic wave oscillator configured to oscillate an electromagnetic wave,
a controller configured to control the electromagnetic wave oscillator;
a first substrate provided with a plurality of discharge emission patterns each having a power receiving end; and
a second substrate provided with a feed pattern having a power receiving port configured to receive a power of the electromagnetic wave from the electromagnetic wave oscillator and a plurality of power feed ends each connected through a via to one of the power receiving ends, a distance on the feed pattern from the power receiving port to each power receiving end of the corresponding discharge emission pattern being equal to one another.
wherein each of the discharge emission patterns is formed in a spiral shape that has at a center thereof around the corresponding power receiving end connected to the feed pattern and has a length which corresponds to ¼ wavelength of the electromagnetic wavelength supplied to the feed pattern.

2. The electromagnetic wave discharge emission device according to claim 1,
wherein a gap is formed between an opening end of each discharge emission pattern and part of the discharge emission pattern which is close to the opening end, and the controller performs a discharge control by supplying from the electromagnetic wave oscillator the electromagnetic wave having an output value that causes a breakdown at the gap, thereby causing a discharge at the gap.

3. The electromagnetic wave discharge emission device according to claim 1,
wherein a gap is formed between an opening end of each discharge emission pattern and part of the discharge emission pattern which is close to the opening end, and the controller performs an emission control so as to emit the electromagnetic wave from a surface of each discharge emission pattern by supplying from the electromagnetic wave oscillator the electromagnetic wave having an output value lower than an output value that causes a breakdown at the gap.

4. The electromagnetic wave discharge emission device according to claim 1,
wherein a gap is formed between an opening end of each discharge emission pattern and part of the discharge emission pattern which is close to the opening end, the controller performs a discharge control by supplying from the electromagnetic wave oscillator the electromagnetic wave having a first output value that causes a breakdown at the gap, thereby causing a discharge at the gap, and performs an emission control for emitting the electromagnetic wave from a surface of each discharge emission pattern by supplying from the electromagnetic wave oscillator the electromagnetic wave having a second output value lower than the first output value.
